(19) United States
(12) Patent Application Publication
(10) Pub. No.: US 2023/0256813 A1
(43) Pub. Date: Aug. 17, 2023

(54) Tank Closure for Motor Vehicles

(71) Applicant: Köhler Automobiltechnik GmbH, Lippstadt (DE)

(72) Inventors: Christian Börnemeier, Lippstadt (DE); Tim Völkerath, Lippstadt (DE)

(21) Appl. No.: 18/014,369

(22) PCT Filed: Jul. 5, 2021
(86) PCT No.: PCT/EP2021/068477

§ 371 Date: Jan. 4, 2023

(30) Foreign Application Priority Data
Jul. 6, 2020 (DE) 20 2020 103 899.0

(51) Int. Cl. B60K 15/04

(52) U.S. Cl. CPC B60K 15/0409; B60K 2015/0438; B60K 2015/0451

(57) ABSTRACT

A tank closure for motor vehicles, includes a locking part (12) for locking on a complementary locking part of the tank nozzle, a closure part (14) for covering an opening of the tank nozzle, and an axially compressible sealing ring (20) surrounding the locking part (12) and supported on a flange (18) of the closure part (14), wherein the flange (18) has, at least on a part of its circumference, a bead (26) which is integrally formed on its surface (24) facing the sealing ring (20) and which is elevated relative to the surface (24), wherein the inner edge of the bead has a radius that is greater than the radius of the peak (34) of the sealing ring.

The invention relates to a tank closure for motor vehicles, comprising a locking part for locking on a complementary locking part of the tank nozzle, a closure part for covering an opening of the tank nozzle, and an axially compressible sealing ring surrounding the locking part and supported on a flange of the closure part.

An example of a tank closure of this type has been described in DE 20 2014 009 044 U1.

It is an object of the invention to provide a tank closure which reliably seals the tank nozzle even when an increased internal pressure is present in the tank of the vehicle, as may for example be the case when, in a hybrid vehicle, the heat generated by the battery leads to an increase of pressure in the tank.

In order to achieve this object, according to the invention, the flange has, at least on a part of its circumference, a bead which is integrally formed on its surface facing the sealing ring and which is elevated relative to said surface, wherein the inner edge of the bead has a radius that is greater than the radius of the peak of the sealing ring.

When the internal pressure in the tank is normal, the sealing ring engages the surface of the flange of the closure part with its peak radially inwardly of the bead, and the axial compression of the sealing ring is just sufficient to assure a gas-tight closure of the tank nozzle but does not lead to fatigue and/or permanent deformation of the sealing ring. When the internal pressure rises, the gas pressure acting upon the internal periphery of the sealing ring has the tendency to widen the sealing ring. Then, however, the sealing ring hits an undercut that is formed by the bead and inhibits the further radial widening of the sealing ring but instead presses the sealing ring more tightly against the edge of the tank nozzle. In this way, the pressure-tightness of the tank closure is improved.

Useful embodiments of the invention are indicated in the dependent claims.

In one useful embodiment, the bead is subdivided in circumferential direction into a plurality of segments that are separated from one another by gaps. Under normal conditions, this further reduces the permanent load on a sealing ring, and when the internal pressure is increased, the segments of the bead dig firmly into the surface of the sealing ring. As a consequence, a breakthrough of the compressed gas can be prevented very reliably.

An embodiment example will now be described in conjunction with the drawings, wherein:

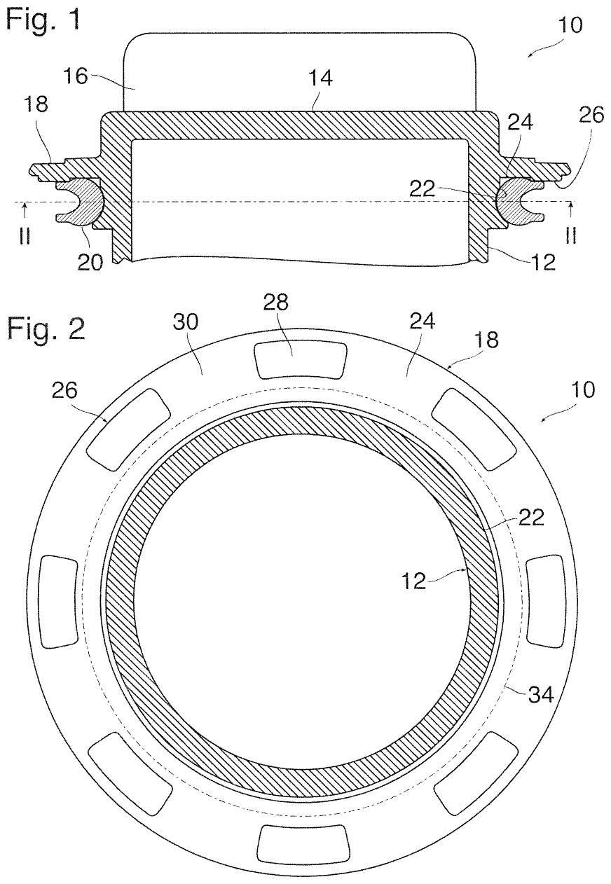

FIG. 1 is an axial sectional view of a tank closure according to the invention; and

FIG. 2 is a cross-sectional view of the tank closure without sealing ring along the line II-II in FIG. 1.

The tank closure shown in FIG. 1 has an overall cup-shaped housing 10 that is injection-molded from plastic, for example, and forms a cylindrical locking part 12 on the inward side and a cylindrical closure part 14 on the outward side. The locking part 12, which has not been shown completely here, is provided for engaging into a mouth of the tank nozzle and can be locked in the tank nozzle by means of a bayonet coupling, for example, such that the mouth of the tank nozzle is closed-off by the closure part 14. The closure part 14 has a handle 16 on its outward side and has a flange 18 extending all along its outer periphery.

On the inward side of the flange 18, the locking part 12 is surrounded by a sealing ring 20 that is made of a rubber-elastic material and has a profile that is typical for this type of sealing ring, the profile having an approximately circular cross-section, but with a trench extending all along the outer periphery and dividing the outer peripheral portion of the sealing ring into two lips so as to increase the axial compressibility of the sealing ring.

The inner peripheral edge of the sealing ring 20 is received in a circumferential crease 22 of the locking part 12 and is thereby form-fittingly immobilized in axial direction of the locking part, whereas an upper peak of the sealing ring is supported on an inward surface 24 of the flange 18.

Radially outwardly of the upper peak of the sealing ring 20, the inward side of the flange 18 forms a circumferential bead 26 which projects from the surface 14. As can be seen in FIG. 2, the bead 26 is subdivided in circumferential direction into eight segments 28 that are separated from one another by gaps 30. The gaps 30 extend respectively over a circumferential angle of preferably not more than 30°.

A line of contact 34 with which the upper peak of the sealing ring 20 engages the surface 24 of the flange 18 has been shown in dot-dashed lines in FIG. 2. It can be seen that the internal edge of the bead 26 is located radially outwardly of the line of contact 34.

In the example shown, the height of the bead 26 relative to the surface 24 amounts to approximately 1/12 to 1/10 of the total height of the sealing ring 20.

If an increased internal pressure is present in the tank nozzle (which has not been shown here) and gas enters into a joint that is formed in the crease 22 between this crease and the sealing ring and has the tendency to radially widen the sealing ring, then the sealing ring is form-fittingly held in position by the elevated parts of the bead 26.

What is claimed is:

1. A tank closure for motor vehicles, comprising:
a locking part for locking on a complementary locking part of the tank nozzle,
a closure part for covering an opening of the tank nozzle, the closure part having a flange, and
an axially compressible sealing ring surrounding the locking part and supported on the flange of the closure part,
wherein the flange has, at least on a part of a circumference thereof, a bead which is integrally formed on a surface thereof facing the sealing ring and which is elevated relative to said surface, and
wherein an inner edge of the bead has a radius that is greater than the radius of a peak of the sealing ring.

2. The tank closure according to claim 1, wherein the bead is subdivided in a circumferential direction into a plurality of segments that are separated from one another by gaps.

3. The tank closure according to claim 2, wherein the gaps extend respectively over a circumferential angle of no more than 30°.

4. The tank closure according to claim 1, further comprising a circumferential crease formed in an outer peripheral wall of the locking part, with an inner peripheral edge of the sealing ring being accommodated in said crease.

5. The tank closure according to claim 1, wherein the height of the bead relative to the surface of the flange amounts to at least 1/12 of the total height of the sealing ring.
